(19) United States
(12) Patent Application Publication
(10) Pub. No.: US 2008/0141805 A1
(43) Pub. Date: Jun. 19, 2008

(54) SWITCHING DEVICE FOR A GROUP TRANSMISSION WITH A LOCKING DEVICE AND A METHOD FOR CONTROLLING SUCH A SWITCHING DEVICE

(75) Inventors: Reinhard BIRK, Wasserburg (DE); Eckhardt LUBKE, Friedrichshafen (DE); Jurgen HALTER, Friedrichshafen (DE); Michael PREUSS, Friedrichshafen (DE)

Correspondence Address: DAVIS BUJOLD & Daniels, P.L.L.C., 112 PLEASANT STREET, CONCORD, NH, 03301, US

(73) Assignee: ZF FRIEDRICHSHAFEN AG, Friedrichshafen (DE)

(21) Appl. No.: 11/956,473

(22) Filed: Dec. 14, 2007

(30) Foreign Application Priority Data
Dec. 15, 2006 (DE) 10 2006 059 191.7

(51) Int. Cl. F16H 63/34; F16H 61/70

(52) U.S. Cl. 74/325; 74/335

(57) ABSTRACT

The invention relates to a shifting device (1) for a group transmission with a first switching device (9) for switching the gear steps of a group, a second switching device (10) for switching the groups of the group transmission, and a locking device (22), which features a locking member (23), which can be moved from a releasing position into a locking position, in which the first switching device (9) is locked in a neutral position. Inventively, the locking member (23) can be moved independently of a switching movement of the second switching device (10) from the releasing position into the locked position. The invention also involves a method for controlling a switching device (1) for a group transmission.

The invention relates to a switching device for a group transmission with a first switching device for switching the gear steps of a group, a second switching device for switching the groups of the group transmission, and a locking device that features a locking member, which can be moved from a releasing position into a locking position, in which the first switching device is locked in a neutral position. In addition, the invention concerns a method for controlling a switching device for a group transmission.

From the state of the art, a plurality of different switching devices is known for the gearboxes of motor vehicles. In the case of the known switching devices, selector plates or selector rods are used, which can be axially displaced by way of a manually actuated gearshift lever or similar means. Through the axial displacement of the selector plates, the desired gear is engaged or the corresponding gear step is shifted. In the case of heavy vehicles in particular, as well as in vehicles whose driver's seat is far away from the gearbox, a high shifting force is required. In order to assist or relieve the driver in such cases, pneumatic servo-power assistance units have become common in commercial vehicles of the aforementioned type, such as buses and trucks. The servo-power assistance units support the displacement of the selector plates so that the switching force does not have to be applied by the driver alone.

DE 198 39 854 A1 describes a switching device of the aforementioned type. The servo-power assistance unit of the known switching device comprises a power assistance unit that can be supplied with compressed air and a storage container filled with compressed air, where the latter is connected with the assistance unit via a connection line. A reducing device is provided in the connection line. With the assistance of the reducing device, the compressed air transferred from the storage containers to the assistance unit can be limited. In this way, adjustment can be achieved to the permissible stresses in the components acted on by the servo force.

In addition to the conventional switching devices for automotive variable-speed transmissions, switching devices are also known for group transmissions. In a group transmission, a front-mounted group is used before the main transmission, such that different input ratios can be selected. It is usually possible to choose between a fast group and a slow group. For this reason, a manually operated group selector switch is provided. By actuating the group selector switch, a group selector plate is moved, by way of pneumatics, into a corresponding shifting position in which the desired group is engaged, where the group selector plate is only moved when the selector plate of the main gearbox is moved into a neutral position.

In the case of known group transmissions, a locking device is also provided, which blocks or locks the selector plate in the neutral position when the group selector plate moves between shifting positions in order to prevent the selector plate of the main gearbox from being moved, while the group selector plate is being moved between shifting positions. The locking devices, known from the state of the art, feature a locking member, which blocks or locks the selector plate in the neutral position when the group selector plate moves between shifting positions. The locking devices feature a locking member that is pre-stressed against the group selector plate by way of a coil spring. On its side facing the locking device, the group selector plate has a contour that follows the locking member, when the group selector plate is moved. In that way, the locking member is moved from a release position into a locking position, where the locking member interacts in such a way with the selector plate of the main gearbox that the selector plate is locked. Only when the group selector plate has reached the corresponding shifting position in which the fast or the slow group is engaged is the selector plate released again with the locking member being moved into the release position by the further movement of the group selector plate.

The known switching devices for group transmissions have proven their worth, however, they do have the disadvantage that the locking devices they utilize cannot guarantee secure and accurately timed locking of the selector plate of the main gearbox. With particularly rapid switching of the selector plate, this can lead to the selector plate being switched past the neutral position, where the group selector plate is moved only into a middle position between the two shifting positions, while a gear step can still be engaged due to the non-locked selector plate. As a result, there is no longer a torque transmitting connection and the vehicle comes to a stop.

The present invention is based on the task of creating a group transmission that overcomes the aforementioned disadvantages. The invention is also based on the task of devising a method for controlling a switching device of a group transmission.

This task is accomplished by way of the features specified in patent claim 1 and/or claim 10. Advantageous embodiments of the invention are the subject of the sub-claims.

The invention relates to a switching device for a group transmission and consists of a first switching device that comprises a selector plate of the main gearbox for switching the gear steps of a group, a second switching device that features a group selector plate for switching the groups of the group transmission and a locking device. The locking device features a locking member that can be moved from a release position into a locked position. In the locked position, the first switching device is locked or blocked in a neutral position. As a result, no further gear step can be engaged. Inventively, the locking member can be moved independently of a shifting movement of the second switching device from the release position into the locked position. In that way, the locking member can be activated by another device, such as a group selector switch, where certain and early locking of the first switching device in the neutral position is possible. In contrast to the known switching devices, the movement of the locking member into the locked position is independent of the movement of a group selector plate or similar to the second switching device.

In a preferred embodiment of the inventive switching device, the locking device features a locking member actuator that can be activated to move the locking member into the locked position. The locking member actuator can only be actuated when it is really needed. In contrast to this, the locking members, known from the state of the art, are pushed permanently by way of a coil spring in the direction of the locked position.

In a preferred embodiment of the inventive switching device, a manually actuated group selector switch is provided for selecting the switching position of the second switching device, where the locking member and the group selector switch interact in such a way that the locking member actuator acts on the locking member only when the position selected by the group selector switch does not correspond to the actual switching position of the second switching device. In this way, the movement of the locking member into the locking position is already provided by actuating the group selector switch, when the driver makes his intention to switch groups clear. This therefore takes place before the change in the switching position of the second switching device, where a certain locking of the first switching device in the neutral position is guaranteed.

In an advantageous embodiment of the inventive switching device, the first switching device interacts in such a way with the second switching device that the first switching device is only moved into the selected switching position when the first switching device is switched into the neutral position.

In a further advantageous embodiment of the inventive switching device, the locking member actuator is a pneumatic, electric or electromagnetic drive.

According to a further advantageous embodiment of the inventive switching device, the locking member is pre-tensioned in the release position. This can be accomplished by way of a coil spring assigned to the locking member.

In an additional preferred embodiment of the inventive switching device, the first switching device features a selector shaft, a selector engaging piece and/or a selector plate, where the locking member in the locked position, locks the selector shaft, the selector engaging piece or the selector rod.

In an additional advantageous embodiment of the inventive switching device, the locking member, in the locked position, engages a recess in the selector shaft, the selector-engaging piece or the selector plate.

In a further preferred embodiment of the inventive switching device, the second switching device comprises a group selector plate and a pneumatic, dual acting cylinder for driving the group selector plate. As already explained above, in the case of this embodiment as well, the locking member can also be moved from the release position into the locked position independently of a switching movement of the group selector plate.

In an additional preferred embodiment of the inventive switching device, the group selector switch for selecting the switching position of the second switching device is configured in such a way that the group selector switch can be electromagnetically moved into a middle switch position when the selected switching position of the second switching device has been reached.

In an advantageous embodiment of the inventive switching device, the switching device features at least one sensor and one control unit. The sensor can be configured as a rotational speed sensor or as a speed sensor and is connected with the control unit. In this case, the second switching device can only be moved into the selected switching position when a corresponding switching requirement is met, for example a speed requirement. The appropriate signal is given by the control unit.

The inventive method for controlling a shifting device for a group transmission includes the process step of providing a switching device for a group transmission with a first switching device for switching the gear steps of a group, a second switching device for switching the groups of the group transmission and a locking device for locking the first switching device into a neutral position, and is characterized by the procedural step of locking the first switching device into the neutral position, independent of any switching movement of the second switching device. As regards the advantages of the inventive method, we refer to the above description of the inventive switching device.

In a preferred embodiment of the inventive method, the switching device provided also features a manually activated group selection switch for selecting the switching position of the second switching device, where the procedural s step of activating the locking device is also provided for, only when the position selected by way of the group selection switch does not correspond to the actual switching position of the second switching device.

In an advantageous embodiment of the inventive method, the second switching device is only moved into the selected switching position when the first switching device is switched into the neutral position.

In a further advantageous embodiment of the inventive method, the locking device is pneumatically, electrically or electromagnetically actuated.

In a particularly preferred embodiment of the inventive method, the provided switching device is an inventive switching device as described above.

The invention is explained in detail below using exemplary embodiments with reference to the appropriate drawing. The following are shown:

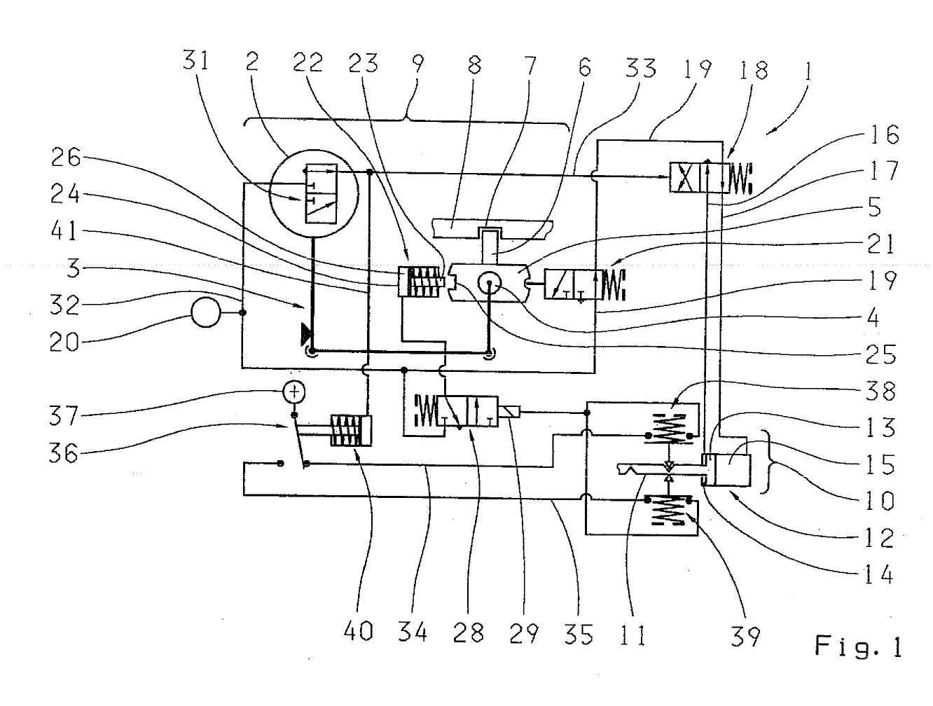

FIG. 1 is a schematic representation of a first embodiment of the inventive switching device for a group transmission;

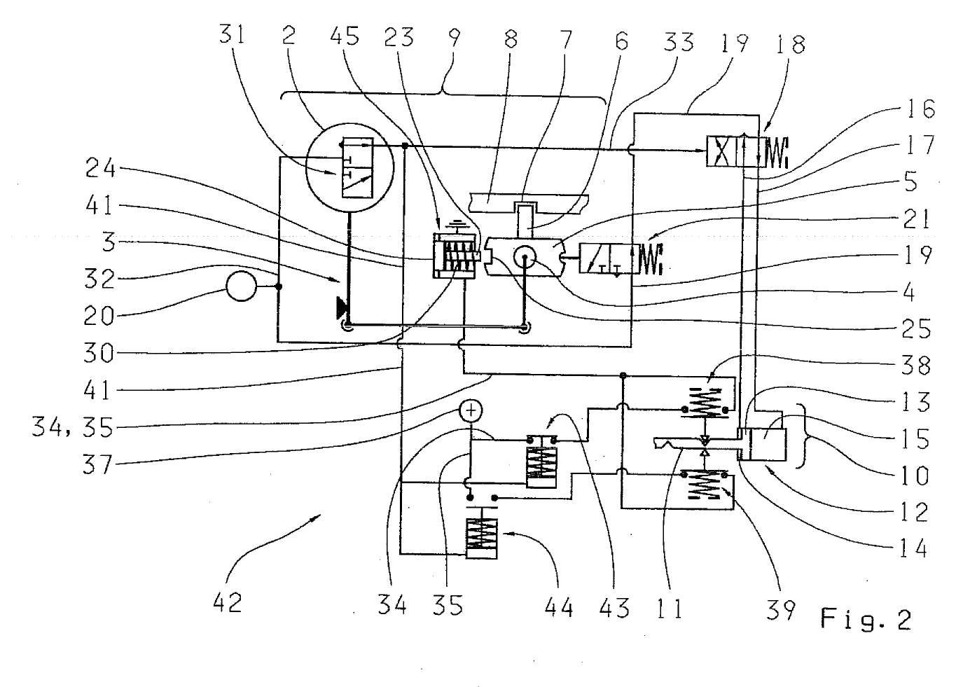

FIG. 2 is a schematic representation of a second embodiment of the inventive switching device for a group transmission;

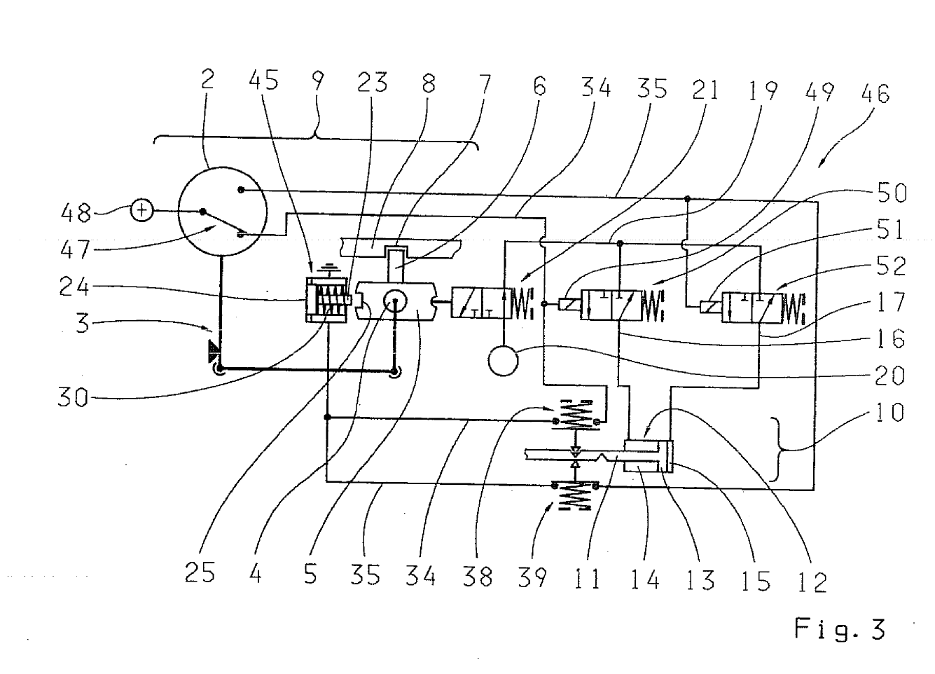

FIG. 3 is a schematic representation of a third embodiment of the inventive switching device for a group transmission, and

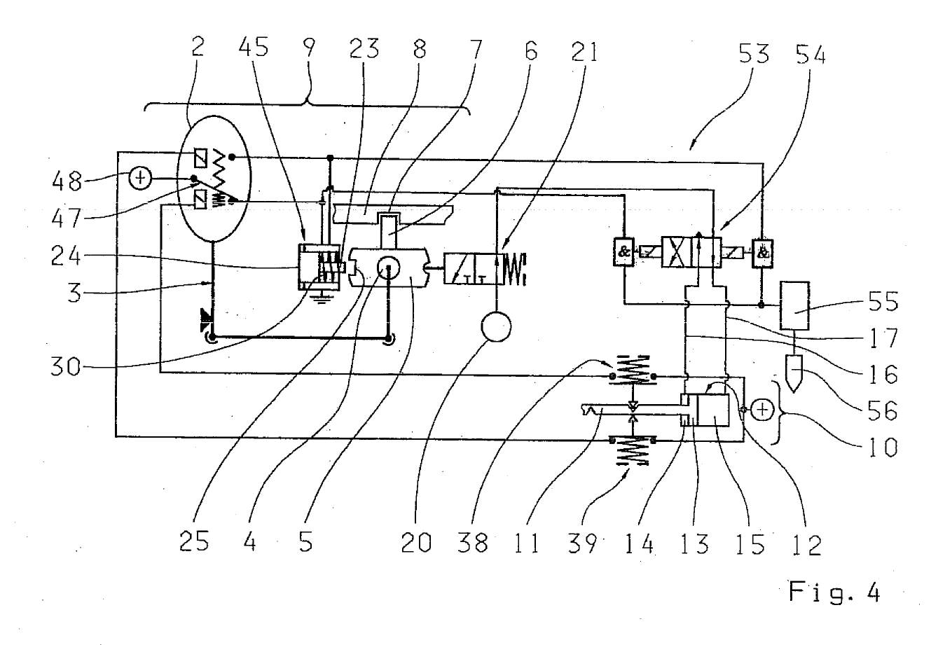

FIG. 4 is a schematic representation of a fourth embodiment of the inventive shifting device for a group transmission.

FIG. 1 shows a schematic presentation of a first embodiment of an inventive switching device 1 for a group transmission. To begin with, the switching device 1 features a manually activated gearshift lever 2 which, when pivoted, transfers a rotational movement, via a corresponding switch linkage 3, to a selector shaft 4. A selector engaging piece 5 is provided on the selector shaft 4, the engaging piece featuring a selector finger 6 that extends radially outward. The selector finger 6 extends radially in a channel 7 in an axially displaceable selector plate 8. By turning the selector shaft 4, the selector plate 8 is displaced longitudinally, in order to switch one gear step of a group. As regards the interaction of the selector plate 8 and the gear steps, reference is made to the state of the art. The gearshift lever 2, the switch linkage 31 the selector shaft 4, the selector engaging piece 5, the selector finger 6, and the selector plate 8 comprise a first switching device 9 for switching the gear steps of one group.

The switching device 1 also includes a second switching device 10 for switching the groups of the group transmission, whereby in the embodiments shown, there can be switching between a fast and a slow group. The second switching device 10 includes a group selector plate 11, which can be axially displaced from a first switching position in which a first group is switched into a second switching position in which a second group is switched. The group selector plate 11 is thereby actuated by a pneumatic, dual-acting cylinder 121 whose piston 13 divides the cylinder chamber into a first and a second chamber 14, 15. Depending on which of the two chambers 14, 15 is acted upon by compressed air, the group selector plate 11 moves forward or backward. A first line 16 leads to the first chamber 14, while a second line 17 opens into the second chamber. Both lines 16, 17 lead with their end facing away from the cylinder 12 to a first pneumatic valve 18, which is configured as a 3/2-way valve.

The first pneumatic valve 18 can be switched from a first position, in which the first chamber 14 is supplied with compressed air into a second position in which the second chamber 15 is supplied with compressed air, which is shown in FIG. 1. The compressed air for the chambers 14, 15 is led via a first supply line 19 of a supply container 20 to the first pneumatic valve 18. In this first supply line 19, a second pneumatic valve 21 is provided, which is configured as a 2/2-way valve. The second pneumatic valve 21 is shifted by the selector engaging piece 5. If the first switching device 9—and thereby also the selector engaging piece 5—is in the neutral position, the second pneumatic valve 21 is open and the supply of compressed air to the first and second chamber 14, 15, via the first supply line 19, is guaranteed. On the other hand, if the first switching device 9 is in a switching position in which a gear step is switched, the second pneumatic valve 21 is closed. A group change using the second switching device 10 is then impossible.

The switching device 1 also features a locking device 22. In the embodiment shown, the locking device 22 includes a bolt-like locking member 23 and a locking member drive 24 that can be actuated. The locking member 23 can be moved with the help of the locking member drive 24 from the releasing position shown in FIG. 1, in which the first switching device 9 is not locked or locked into a locked position (not shown) in which the first switching device 9 is locked in the neutral position. In order to lock the first switching device 9, the locking member 23, in the locked position, engages a recess 25 in the selector engaging piece 5 so that the latter can no longer be turned.

The locking member drive 24 is configured as a pneumatic drive that includes a drive cylinder whose chamber 26 can be acted upon by compressed air, via a second supply line 27, whereby the second supply line 27 has a direct connection with the first supply line 19 or is connected directly with the supply container 20. A third pneumatic valve 28 is also arranged in the second supply line 27. The third pneumatic valve 28 is also configured as a 2/2-way valve and is switched by an electromagnet 29. The function of the third pneumatic valve 28 will be explained in more detail below. If the chamber 26 of the drive cylinder is not acted upon by pressure, the locking member is pre-tensioned in the release position with the help of a coil spring 30.

The switching device 1 also shows a manually actuated group selector switch 31 for selecting the switching position of the second switching device 10. In the embodiment shown, the group selector switch 31 is configured as a fourth pneumatic valve, which is connected, via a third supply line 32, with the supply container 20 and with a control line 33 that leads to a first pneumatic valve 18. The first pneumatic valve 18 is switched, subject to the position of the fourth pneumatic valve or the group selector switch 31. The group selector switch 31 or the fourth pneumatic valve can be switched into a first position, which is shown in the Figures, and in which no compressed air is passed on to the control line 33, as well as into a second position in which the compressed air passes across the third supply line 32 into the control line 33 to the first pneumatic valve 18 in order to switch it.

In the switching device 1, a first electric cable 34 and a second electric cable 35 are also provided, which can be connected optionally, via a switch 36, with a power supply unit 37. Both electric cables 34, 35, respectively, supply the electromagnet 29. In the first electric cable 34, there is a mechanically activated first switch 38 and, in the second electric cable 35, there is a mechanically activated second switch 39, where the first and second switches 38, 39 can be activated by the group selector plate 11 when it is moved in a longitudinal direction into different positions. The switch 36, for optionally connecting the power supply unit 37 with the electric cables 34, 35, can be activated by way of a pushbutton-type switch 40, which is connected, via a fourth supply line 41, to the control line 33.

The mode of operation and additional characteristics of the first embodiment of the switching device 1 are described below with reference to FIG. 1. First, it is assumed that the group transmission is switched into the slow group in the position of the switching device 1 shown in FIG. 1. In order to select the fast group, the driver activates the group selector switch 31 in the other position, i.e., he selects the switching position of the second switching device 10 for the fast group. In this way, the compressed air passes from the supply container 20 via the third supply line 32 into the control line 33, where it causes the first pneumatic valve 18 to switch. At the same time, compressed air reaches the pushbutton switch 40 via the control line 33 and the fourth supply line 41 which moves the switch 36 so that the power supply source 37 is connected with the second electric cable 35. As the first mechanically actuated switch 39 is in the closing position, the electromagnet 29 is supplied with current via the second electric cable 35 so that the third pneumatic valve 28 is switched into the opening position. In that way, compressed air can pass via the third supply line 27 into the chamber 16 of the locking device 22 so that the locking member drive 24 acts on the locking member 23, in order to move the latter into a locked position.

The locking member 24 and the group selector switch 31 interact in such a way that the locking member drive 24 only acts on the locking member 23, when the switching position selected by way of the group selection switch 31 does not correspond to the actual switching position of the second switching device 10 or the group selector plate 11. This is done in this embodiment by way of the first and second mechanically activated switches 38, 39. For example, if the second switching device 10 is already switched into a switching position in which the fast group is selected, the second switch 39 would be open. Even if the group selector switch 31 is switched to the fast group, this would not lead to a locking of the first switching device 9 by the locking device 22 as the second mechanically activated switch 39 interrupts the second electrical line 35.

It can be seen from the above description that the locking member 23 can be moved independently of a switching movement of the second switching device 10 from the releasing position into the locked position and that this can actually already be done when the driver has only indicated his intention for a change in group by switching the group selector switch 31. Only after that, does the actual switching of the second switching device occur, as described below.

By switching the first pneumatic valve 18 with the assistance of compressed air in the control line 33, the compressed air from the supply container 20 is now led, via the second supply line 19, into the first chamber 14 inside the cylinder 12. A prerequisite for this, however, is that the first switching device 9 is in the neutral position—which is the case in the present example—so that the second pneumatic valve 21 in the second supply line 19 is also open. The locking member 23 can only be moved after reaching the neutral position in the recess 25 in the selector-engaging piece 5 in order to lock the engaging piece. As the first chamber 14 is now filled with compressed air, the group selector plate 11 is moved from the switching position shown into a second switching position in order to implement the group change. As the first switching device 9 is locked during the group change, the selector plate 8 can no longer be moved in a longitudinal direction, in order to switch to another gear step.

FIG. 2 shows a second embodiment of an inventive switching device 42, which is largely similar to the first embodiment, so that only the difference between it and the first embodiment will be described below. The same reference signs are used for the same or similar parts, so that the above description applies correspondingly in this respect.

In the case of the second embodiment, the push-button switch 40 (FIG. 1) is omitted in favor of a first pressure switch 43 in the first electric cable 34 and a second pressure switch 44 in the second electric cable 35. The first and the second pressure switches 43, 44 are supplied with compressed air via the fourth supply line 41, where the first pressure switch 43 opens when pressure is applied to it, while the second pressure switch 44 would closed in that case. In addition, a locking device 45 is configured as an electromagnetic locking cylinder in the second embodiment, which can be directly supplied with current via the electric cables 34, 35.

FIG. 3 shows a third embodiment of an inventive switching device 46, which is partially similar to the first and the second embodiment, so that only the differences between it and the first and second embodiment will be described below. For the same or similar parts, the same reference signs will be used so that the above description applies correspondingly in this respect.

In contrast to the two previous embodiments, a group selector switch 47 is configured as an electronic switch that can selectively connect a power source unit 48 with the first or second electric cable 34, 35. A first electromagnet 49 for actuating a pneumatic valve 50 in the line 16 is supplied via the first electric cable 34, while a second electromagnet 51 is provided for actuating a pneumatic valve 52 in the line 17. Both electric cables 34, 35 lead, as in the second embodiment, to the electromagnetic locking cylinder of the locking device 45. In this embodiment, the compressed air in the supply container 20 no longer serves the purpose of actuation; it only produces movement of the group selector plate 11 of the second switching device 10.

FIG. 4 shows a fourth embodiment of an inventive switching device 53, which is partially similar to the previous embodiments, so that only the differences between it and the first and second embodiments will be described below The same reference signs are used for the same or similar parts so that the above description applies correspondingly in this respect.

In the fourth embodiment of the inventive switching device 53, instead of two pneumatic valves 50, 52, only one pneumatic valve 54 is used, which is controlled, via a control unit 55. The control unit 55 is configured as an electronic module and is connected with a sensor 56, such as a rotational speed sensor or a speed sensor. The group switch 47 here features three switching positions, two switch-on positions for switching the groups of the group transmission and a middle switch position. The pneumatic valve 54 is actuated, when the group switch 47, at gearshift lever 2, is switched to one of its switch-on positions and the requirement of control unit 55 is met (AND-operation). After actuating the group selector switch 47 in one of its switch-on positions, the locking member 23 is directly activated. As soon as the gearshift lever 2 is in its neutral position, any shifting within the first switching device 9 is prevented by the locking member 23, because a switching movement of the selector plate is locked. In order to carry out a switch via the second switching device 10, a corresponding switching requirement must be present in the control 55, for example, an electronic speed requirement. A signal for this is detected by the sensor 56 and passed on to the control unit 55, which then emits another signal at an exit. During the switching of one group of the group transmission via the second switching device 10, the group selector switch 47 remains in the switch-on position for the desired group. The locking member 23 remains activated. After switching the group (the group selector plate 11 has reached its second switching position), an electromagnet in the group selector switch 47 is supplied with current or is actuated so that the group selector switch 47 assumes its middle position. If the group selector switch 47 is in its middle position, the circuit to the locking member drive 24 is interrupted, where the switched group of the group transmission is retained. The locking member 23 is then no longer actuated and the lock on the selector plate 8 is overridden. The vehicle driver can then complete shifting process correspondingly, via the gearshift lever 2.

### REFERENCE NUMERALS

1 switching device (first embodiment)
2 gearshift lever
3 switch linkage
4 selector shaft
5 selector engaging piece
6 selector finger
7 channel
8 selector plate
9 first switching device
10 second switching device
11 group selector plate
12 pneumatic, dual-acting cylinder
13 piston
14 first chamber
15 second chamber
16 first line
17 second line
18 first pneumatic valve
19 first supply line
20 supply container
21 second pneumatic valve
22 locking device
23 locking member
24 locking member drive
25 recess
26 chamber
27 second supply line
28 third pneumatic valve
29 electromagnet
30 coil spring
31 group selector switch
32 third supply line
33 control line
34 first electric cable
35 second electric cable
36 switch
37 power supply source
38 first mechanically actuated switch
39 second mechanically actuated switch
40 pushbutton type switch
41 fourth supply line
42 switching device (second embodiment)
43 first pressure switch (opener)
44 second pressure switch (closer)
45 locking device (electromagnetic locking cylinder)
46 switching device (third embodiment)
47 group selector switch (electric switch)
48 power supply source
49 first electromagnet
50 pneumatic valve
51 second electromagnet
52 pneumatic valve
53 switching device (fourth embodiment)
54 pneumatic valve
55 control unit, electronic module
56 sensor

1-16. (canceled)

17. A switching device for a group transmission, the switching device comprising:
a first switching device (9) for switching gear steps of a group,
a second switching device (10) for switching groups of the group transmission, and
a first locking device (22, 45) including a locking member (23), that is movable between a release position and a locked position, for locking the first switching device (9) in a neutral position, and the locking member (23) being movable, independently of a switching movement of the second switching device (10), from the release position into the locked position.

18. The switching device according to claim 17, wherein the first locking device (22, 45) has a locking member drive (24) which is actuated to bias the locking member (23) into the locked position.

19. The switching device according to claim 18, wherein a manually actuated group selector switch (31, 47) adjusts a shifting position of the second switch device (10), and the locking member drive (24) and the group selector switch (31, 47) interact such that the locking member drive (24) only biases the locking member (23), when the shifting position of the second switch device (10), adjusted by the group selector switch (31, 47), does not correspond to an actual shifting position of the second switching device (10).

20. The switching device according to claim 17, wherein the first switching device (9) interacts with the second switching device (10) such that the second switching device (10) is moved into a selected shifting position only when the first switching device (9) is switched into the neutral position.

21. The switching device according to claim 18, wherein the locking member drive (24) is one of pneumatically, electrically, and electromagnetically driven.

22. The switching device according to claim 17, wherein the locking member (23) is pre-tensioned in the release position.

23. The switching device according to claim 17, wherein the first switching device (9) comprises at least one of a selector shaft (4), a selector engaging piece (5) and a selector plate (8), and the locking member (23), when in the locked position, locks at least one of the selector shaft (4), the selector engaging piece (5), and the selector plate (8).

24. The switching device according to claim 23, wherein the locking member (23), when in the locked position, engages a recess (25) in one of the selector shaft (4), the selector-engaging piece (5) and the selector plate (8).

25. The switching device according to claim 17, wherein the second switching device (10) comprises a group selector plate (11) and a pneumatic, dual-acting cylinder (12) for driving the group selector plate (11).

26. The switching device according to claim 17, wherein a group selector switch (47) switches a shifting position of the second switching device (10) and the group selector switch (47) is moved electromagnetically into a middle switching position when the second switching device (10) is switched into a selected switching position.

27. The switching device according to claim 17, wherein at least one sensor (56) transmits a signal to a control unit (55), and the second switching device (10) is only switched into a selected shifting position when the signal transmitted to the control unit (55) satisfies a corresponding shifting requirement in the control unit (55).

28. A method of controlling a switching device for a group transmission, the method comprising the steps of:
providing a switching device with a first switching device for switching gear steps of a group of the group transmission;
providing the switching device with a second switching device for switching groups of the group transmission;
providing the switching device with a locking device for locking the first switching device in a neutral position; and
locking the first switching device in the neutral position independently of a switching movement of the second switching device.

29. The method according to claim 28, further comprising the step of selecting a shifting position of the second switching device with a manually-actuable group selector switch; and
activating the locking device only when the shifting position selected with the manually-actuable group selector switch is different than an actual shifting position of the second switching device.

30. The method according to claim 28, further comprising the step of moving the second switching device into the selected shifting position only if the first switching device is in the neutral position.

31. The method according to claim 28, further comprising the step of adjusting the locking device one of pneumatically, electrically, and electromagnetically.
